(19) United States
(12) Patent Application Publication
(10) Pub. No.: US 2005/0069676 A1
(43) Pub. Date: Mar. 31, 2005

(54) Etched article, mold structure using the same and method for production thereof

(76) Inventors: Koichiro Nakamura, Tokyo (JP); Kenichi Yamada, Tokyo (JP); Hiroyuki Nemoto, Tokyo (JP)

Correspondence Address: WHITHAM, CURTIS & CHRISTOFFERSON, P.C.;SUITE 340, 11491 SUNSET HILLS ROAD, P.O. Box 9204, RESTON, VA, 20190, US

(21) Appl. No.: 10/948,669

(22) Filed: Sep. 24, 2004

(30) Foreign Application Priority Data
Sep. 26, 2003 (JP) P2003-336160
Jul. 26, 2004 (JP) P2004-216945

(51) Int. Cl. B32B 1/00

(52) U.S. Cl. 428/141

(57) ABSTRACT

A mold structure according to the invention is formed by: injecting a fluid substance in a forming mold having a concave portion having a predetermined sectional shape; hardening the fluid substance; and releasing the fluid substance from the forming mold. The center-line average roughness Ra of the surface of the mold structure is selected to be not larger than 20 nm, preferably not larger than 8 nm. The center-line average roughness Ra of a portion of the forming mold having come into contact with the fluid substance is also selected to be not larger than 20 nm, preferably not larger than 8 nm. To produce such a forming mold, the specific resistance of water used for adjusting an aqueous solution at the time of formation of the concave portion in the glass surface by a chemical etching method is selected to be not lower than 13 M Ω·cm.

The present application is based on Japanese Patent Applications Nos. 2003-336160 and 2004-216945, the entire contents of which are incorporated herein by reference.

### BACKGROUND OF THE INVENTION

1. Field of the Invention

The present invention relates to a mold structure requiring the precision surface shape of an optical element and the like, and a method for producing the mold structure.

2. Related Art

A great deal of planar optical elements each having a predetermined micro concave-convex structure provided in its surface to thereby utilize the action of diffraction or refraction of light have been recently used in the field of optical communication with the advance of increase in information communication capacity. For example, diffraction gratings, micro-lens arrays, etc. are known well as examples of the planar optical elements.

There are known various methods for forming such concave-convex structures in these surfaces. If a glass material is used, glass lenses can be formed by high-temperature molding or etching. However, it cannot be said that the method for producing such glass lenses is adapted for low-cost mass production.

On the contrary, a resin molding technique is known as a method adapted for low-cost mass production. In this method, a photo-curable resin is filled in between a transparent substrate and a forming mold (stamper) having a concave-convex structure and irradiated with light to thereby be cured. For example, an optical element using a molding resin formed by this method has been disclosed in Japanese Patent Publication No. JP S63-49702A.

Various methods are known for production of a forming mold (stamper) having a concave-convex structure as used for such molding. For example, a method for forming a spherical concave portion by chemically etching a glass substrate isotropically through a mask having a circular opening has been disclosed in Japanese Patent Publication No. JP H03-232743A. When a resin filled between the forming mold of glass produced in this manner and a planar transparent substrate and cured is released from the forming mold, a lens or a lens array can be produced (e.g. see Japanese Patent Publication No. JP H07-225303A).

Or when a resin having a higher refractive index than that of glass is filled in a spherical concave portion as disclosed in Japanese Patent Publication No. JP H03-232743A, a lens can be also formed.

The structure formed by molding of a resin has been applied not only to production of an optical element but also to production of a micro flow path structure for performing a chemical reaction of a liquid substance in a micro region (e.g. see Japanese Patent Publication No. JP 2003-62797A). Glass can be processed into an accurate shape by etching, so that a forming mold of glass has high durability. Accordingly, glass is adapted for production of a mold structure used for the aforementioned purpose. On the other hand, when a photo-curable resin is used, there is an advantage that the direction of light irradiation is little limited because light irradiation can be made through the forming mold.

When etching is made such that an etching solution is brought into contact with glass, surface roughness however may occur in the etched surface. In an extreme case, the glass substrate obtained is shaped like frosted glass because of the surface roughness. If the frosted glass-shaped glass substrate is used as a forming mold, it is difficult to perform mold releasing. In addition, the original properties of the glass forming mold are lost because the surface of the molded structure is not smooth.

### SUMMARY OF THE INVENTION

The invention is designed to solve the problem in the related art and an object of the invention is to provide a mold structure having a smooth surface small in surface roughness.

Another object of the invention is to provide a forming mold having a smooth surface small in surface roughness and formed by chemical etching. A further object of the invention is to provide a method for producing a mold structure or an etched article having a smooth surface small in surface roughness.

The invention provides an etched article formed by etching a predetermined portion of a surface of a base material made of a solid body such that an aqueous solution containing a component capable of dissolving the solid body is brought into contact with the predetermined portion of the surface of the base material so as to form a concave or convex portion, wherein the center-line average roughness Ra of the etched predetermined portion of the surface of the base material is not larger than 20 nm, preferably not larger than 8 nm.

For the lower limit of the center-line average roughness Ra, it is preferable that the center-line average roughness Ra is as small as possible (close to 0).

When the etched article is used as a forming mold, the surface of the forming mold is smooth. Accordingly, when a mold structure formed by filling a fluid substance such as a resin in the concave portion of the forming mold and hardening the fluid substance is used, for example, as an optical element, the optical element can be obtained as a good element little in interfacial light scattering.

Preferably, the solid body to be etched is glass. Especially preferably, the glass is one member selected from the group consisting of quartz glass, non-alkali glass, and soda-lime silicate glass.

When glass is etched, a smooth surface can be obtained.

The invention provides a mold structure including a base material defined above, and a fluid substance hardened after filled in the concave portion of the surface of the base material.

Preferably, in this case, the base material and the hardened fluid substance are transparent to light with a predetermined wavelength but are different in refractive index from each other.

Because light can be transmitted through the whole mold structure, a transmission type optical element can be formed by use of the refractive index difference.

The invention also provides a mold structure including a fluid substance hardened after filled in the concave portion of the surface of a base material defined above, the fluid substance being separated from the base material after hardened, wherein the center-line average roughness Ra of a portion of the surface of the mold structure having been brought into contact with the forming mold is not larger than 20 nm, preferably not larger than 8 nm.

Because the surface of the forming mold is smooth, the fluid substance can be easily released from the forming mold after hardened. In addition, the surface of the mold structure formed in this manner can be made smooth to the same degree. Accordingly, when the mold structure is used, for example, as an optical element, the optical element can be obtained as a good element little in light scattering on the surface.

Preferably, in the case of such a mold structure, the mold structure is transparent to light with a predetermined wavelength.

Because light can be transmitted through the whole mold structure, a transmission type optical element can be formed.

Preferably, the etched article has a concave portion substantially shaped like a semi-circle in sectional view.

In chemical etching of an isotropic substance such as glass, it is substantially easiest to form a substantially spherical concave portion. When a base material having a plurality of substantially spherical concave portions formed therein is used as a forming mold, a micro-lens array or the like can be produced easily.

The invention provides a method of producing an etched article by chemically etching a predetermined portion of a surface of a base material made of a solid body such that an aqueous solution containing a component capable of dissolving the solid body is brought into contact with the surface of the base material to form a concave or convex portion in the predetermined portion of the surface of the base material. In this case, the specific resistance of water used for adjusting the aqueous solution and water used for cleaning before and after etching is not lower than 13 M Ω·cm.

The surface of the solid body etched in this condition can be flattened.

For the upper limit, it is preferable that the specific resistance of water is as high as possible. In practical use, ultrapure water having the specific resistance of 18 M Ω·cm is available so far.

Preferably, the solid body is glass. Especially preferably, the glass is one member selected from the group consisting of quartz glass, non-alkali glass, and soda-lime silicate glass. Preferably, the component capable of dissolving the solid body is hydrofluoric acid.

When the condition of specific resistance of water is applied to the case where glass is etched with hydrofluoric acid, a smooth etched surface can be obtained.

The invention also provides a method of producing a mold structure including by the steps of: filling a fluid substance in a concave portion of an etched article serving as a forming mold, the concave portion having a predetermined sectional shape; hardening the fluid substance; and releasing the fluid substance from the forming mold. Preferably, the center-line average roughness Ra of the portion of the forming mold brought into contact with the fluid substance in the mold structure forming process is set to be not larger than 20 nm, preferably not larger than 8 nm, and a releasing agent layer is formed on the portion of the forming mold.

Because the releasing agent layer is formed while the surface of the forming mold is smoothened, mold releasing can be made easily after molding, so that a mold structure onto which the shape of the forming mold is transferred accurately can be formed.

According to the invention, an etched article having a smooth surface can be obtained. Accordingly, when a mold structure formed by filling a fluid substance such as a resin in the concave portion of the etched article and hardening the fluid substance is used, for example, as an optical element, the optical element can be obtained as a good element little in interfacial light scattering. In addition, when the etched article is used as a forming mold, mold releasing can be made easily because the surface of the forming mold is smooth. As a result, a mold structure small in surface roughness can be provided.

### BRIEF DESCRIPTION OF THE DRAWINGS

FIG. 1 is a typical view showing a procedure for producing a molding tool by chemical etching according to the invention;

FIG. 2 is a flow chart showing a molding tool producing process according to the invention; and

FIG. 3 is a typical view showing a micro-lens array as an embodiment of the invention.

### DETAILED DESCRIPTION OF THE PREFERRED EMBODIMENTS

An embodiment of the invention will be described below in detail.

After filled in a forming mold provided with a concave portion having a predetermined sectional shape, a fluid substance such as a resin monomer is hardened to thereby produce a mold structure. Accordingly, the forming mold performs a very important role. A method for forming a concave portion in a surface of a substrate by chemical etching is used in this invention. This method will be described below.

The chemical etching method used in the invention is a method for etching a solid body used as a forming mold such that an aqueous solution (etching solution) containing a component capable of dissolving the solid body is brought into contact with a surface of the solid body. Examples of the forming mold used in this invention, that is, examples of the solid body to be etched include glass, ceramics, semiconductor, metal, resin, etc.

Of these, glass has properties adapted to the forming mold because glass is too hard to be deformed, excellent in chemical durability, low in thermal expansion coefficient and high in heat resistance. When a photo-curable resin is used as a molding material, there is an advantage in terms of process that the molding material can be irradiated with light transmitted through the forming mold.

Examples of the glass which can be used as the forming mold may include: quartz glass (linear expansion coefficient α=0.5 ppm/K); non-alkali glass; soda-lime silicate glass; and so on. Examples of the glass may further include: low-expansion crystallized glass such as Zerodur (SCHOTT, α=−2 ppm/K), Neoceram (Nippon Electric Glass Co., Ltd., α=0.15 ppm/K), etc.; Pyrex (Corning Incorporated, α=3.25 ppm/K); BK7 (SCHOTT, α=7.1 ppm/K); and so on.

(Etching Process of Glass)

Examples of the etching solution used for chemical etching of glass include hydrofluoric acid, sulfuric acid, nitric acid, hydrofluoride buffer, phosphoric acid, aqueous hydrogen peroxide, ammonium fluoride, sodium hydroxide, and potassium hydroxide. The etching solution inclusive of a mixture solution etc. of these examples can be selected in accordance with the material.

The chemical etching includes the steps of: pre-cleaning the solid body; diluting the chemical etching solution; and cleaning the chemical etching solution after etching the solid body with the chemical etching solution. Water is used in these steps.

The inventors have found that the flatness of the surface of the solid body obtained by etching can be improved when the specific resistance of water used in these steps is increased. The effect obtained by use of water high in specific resistance is particularly remarkable for water used in the step just before the step of bringing the chemical etching solution into contact with the surface of the solid body.

The specific resistance of water is selected to be preferably not lower than 13 M Ω·cm, more preferably not lower than 15 M Ω·cm, especially preferably not lower than 17 M Ω·cm.

When the solid body is etched in the condition that water having specific resistance of not lower than 17 M Ω·cm is used as water used in the chemical etching process, the surface of the solid body can be obtained as a surface exhibiting excellent flatness of not larger than 1.5 nm in terms of center-line average roughness Ra.

Incidentally, the center-line average roughness Ra is defined as follows. Surface roughness measured in a range of distance L by a tracer type surface roughness tester etc. is expressed as a function f(x) with respect to position x. Then, the center line of roughness is selected so that the integrated value of f(x) in the range of L is equal to zero. On this occasion, the average of integrated values of absolute values of f(x) in the range of L is defined as the center-line average roughness Ra and expressed as a length (nm).

Water having high specific resistance measured in this manner is generally called “ultrapure water”. The ultrapure water can be produced by use of an ultrapure water producing apparatus available on the market. Examples of the ultrapure water producing apparatus may include Autopure WD500 (Millipore Corp.), and Purelite PRB-002 (Organo Corp.).

When the forming mold excellent in surface flatness and produced by the aforementioned method is used as a die for press molding using photo-curable resin or injection molding, a replica optical element made of a resin and excellent in surface flatness can be produced. Examples of the replica optical element may include a lens array, a diffraction grating (inclusive of an echelette diffraction grating, an echelon diffraction grating, an echelle diffraction grating, etc.), a Fresnel lens, an optical waveguide, and so on.

The mold structure which can be provided according to the invention is not limited to the optical element. For example, a micro flow path structure for controlling a chemical reaction of liquid in a micro space may be produced according to the invention.

Examples of the resin used for the aforementioned molding may include a heat-curable resin, and an ultraviolet-curable resin. Specific examples of the heat-curable or ultraviolet-curable resin include an epoxy resin, an acrylic resin, a phenol resin, a melamine resin, an urea resin, a polyimide resin, a polyether-imide resin, a silicone resin, a sol-gel material, and so on.

Next, the process for producing a micro-lens forming mold will be described specifically by way of example.

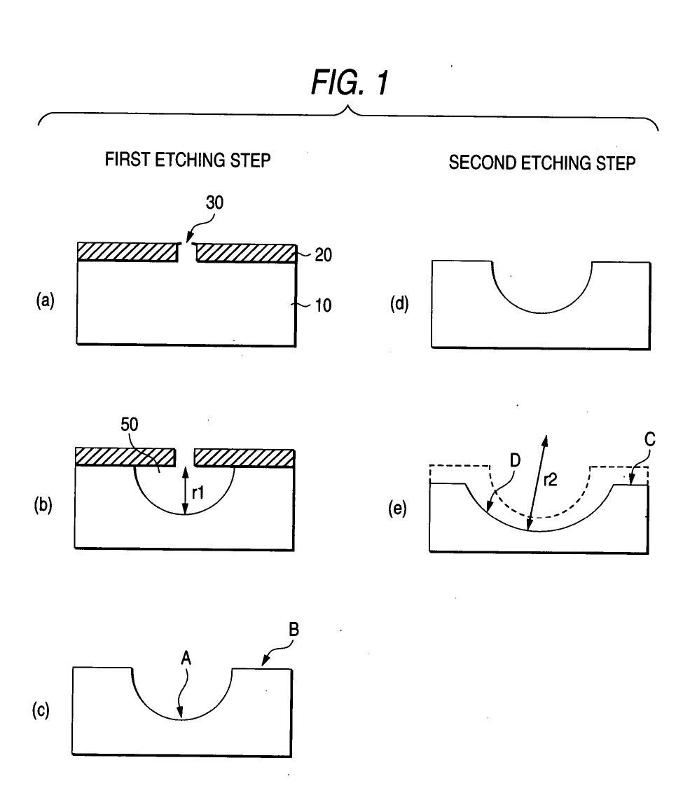

A two-step etching method as described in Patent JP H03-232743A can be used for production of a micro-lens forming mold by a chemical etching method. As shown in step (a) in FIG. 1, a surface of a glass substrate 10 as a base material to be etched is coated with a corrosion-resistant film 20. A pattern of an opening portion 30 designed according to the shape and arrangement of a lens to be produced is formed in the film 20.

The corrosion-resistant film 20 is formed from Ni, Au, Cr, etc. by vapor deposition, sputtering or the like. The aforementioned pattern is formed in the film 20 by photolithography. In the case of a spherical lens, a circular opening is provided. In the case of a cylindrical lens, a linear slit-shaped opening is provided.

An etching solution such as hydrofluoric acid, sulfuric acid, nitric acid, hydrofluoride buffer or a mixture solution thereof is brought into contact with the glass substrate to thereby etch the surface of the glass substrate 10 through the opening portion 30 (step (b) in FIG. 1). On this occasion, the etching treatment is terminated in a stage that the size r1 of a concave portion 50 obtained by etching is smaller than the designed lens size r2. After the etching treatment is terminated, the corrosion-resistant film 20 is removed (step (c) in FIG. 1). The steps (a) to (c) are called “first etching step”.

Then, etching treatment is carried out on the whole surface of the substrate (step (d) in FIG. 1). The step (d) is called “second etching step”. The size of the concave portion is enlarged by the etching so as to be adjusted to a desired lens size r2 (step (e) in FIG. 1). When the two etching steps are carried out in this manner, a forming mold for obtaining a lens small in aberration of the peripheral portion can be produced.

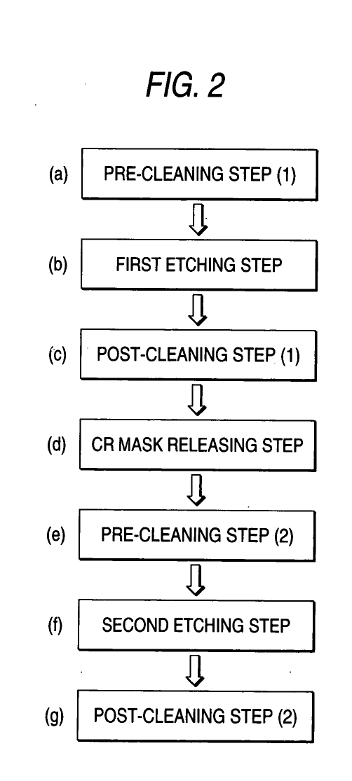

In such a process including etching, cleaning steps before and after etching perform an important role. FIG. 2 is a flow chart showing the overall configuration of a forming mold producing process including cleaning steps. Generally, water is used in each of cleaning steps ((a), (c), (e) and (g) in FIG. 2). The specific resistance of water used is selected to be preferably not lower than 13 M Ω·cm, more preferably not lower than 15 M Ω·cm, especially preferably not lower than 17 M Ω·cm.

When such water is used at least in the cleaning steps ((b) and (f) in FIG. 2) just before the first and second etching steps, a glass forming mold excellent in flatness is obtained so that the center-line average roughness Ra of a glass surface A of a portion (see step (c) in FIG. 1) after completion of the first etching step or of glass surfaces C and D of respective portions (see step (e) in FIG. 1) after completion of the second etching step is preferably not larger than 20 nm, more preferably not larger than 12 nm, most preferably not larger than 8 nm.

Incidentally, the surface B shown in step (c) in FIG. 1 is the original surface of the glass substrate which has been not etched yet. It is preferable that the surface B has the same surface roughness as described above. The surfaces C and D are equivalent to surfaces which will come into contact with a fluid substance such as a resin in a subsequent molding step. Accordingly, when a replica is formed by use of such surfaces excellent in flatness, surfaces on the molded side can be also made excellent in flatness.

Although FIG. 1 shows the case where the forming mold has only one concave portion, a micro-lens array forming mold can be produced when a glass substrate 10 having a corrosion-resistant film 20 provided with a plurality of mask opening portions 30 is used.

### EXAMPLE

A 6-inch quartz glass substrate cleaned and dried in advance was prepared as a base material to be processed into a forming mold. Five kinds of cleaning water different in specific resistance, that is, cleaning water 1 (18 M Ω·cm), cleaning water 2 (17 M Ω·cm), cleaning water 3 (15 M Ω·cm), cleaning water 4 (13 M Ω·cm) and cleaning water 5 (10 M Ω·cm) were prepared in order to examine the surface state after etching in advance.

After pre-cleaned with each kind of cleaning water, the quartz glass substrate was immersed in 49% hydrofluoric acid for an hour to perform chemical etching. Then, the hydrofluoric acid was removed by the same kind of cleaning water as used in the pre-cleaning, and the quartz glass substrate was dried at 40° C. for an hour.

The center-line average roughness Ra of the glass surface was measured. Also linear transmittance of each glass was obtained. That is, parallel light is incident into the glass, and light intensity of the linear light passing through the glass was measured by a photodetector disposed on a rear side of the glass. The photodetector is disposed at a position to which the input light straightly advances, taking into consideration so as not to receive scattered light. The linear transmittance of the glass is obtained by dividing a measured light intensity of the straightly advancing light by the input light intensity.

Table 1 shows the obtained results. The glass surface which was subjected to etching with the cleaning water 1 has linear transmittance not lower than 91%. Since the refractive index of the glass is about 1.46, and Fresnel reflectivity is about 8%, combining front and back surfaces of the glass, the linear transmittance not lower than 91% implies that scattering of light is hardly occurred in the glass.

On the other hand, as for Ra of the glass surface which was subjected to etching with the cleaning water 5, the measurement results are ranged from 10 to 28 nm for plural test pieces subjected to etching on the same condition. Moreover, the linear transmittance was 78%, which was the lowest among the five cleaning waters. That is, the glass surface is not in a state of optical mirror, and the scattering of light occurred of the surface. A glass having such the surface can not be served for optical element like micro lens.

The glass surface which was subjected to etching with the cleaning water 4, the measurement results of the Ra as described above are ranged from 8 to 20 nm, and the linear transmittance was not lower than 86%. The properties are significantly improved. A glass having such the surface may be employed in an application in which the required accuracy in optical properties is so strict.

The glass surface which was subjected to etching with the cleaning water 2, the measurement results of the Ra as described above are ranged from 1 to 8 nm, and the linear transmittance was not lower than 90%. An optical surface on which scattering of light is extremely small can be obtained. For applications in which high accuracy in optical properties is required, it is more desirable to use such the optical surface.

As described above, it is clarified that there exists a desirable range of surface roughness of the optical surface required for suitable optical properties (here, linear transmittance). Further, it has been clarified that there exists a range of specific resistance of cleaning water to obtain desirable surface roughness.

Detailed description will be made for fabrication of mold to form micro lens arrays by resin.

TABLE 1

| | | | | Mold |
|---|---|---|---|---|
| | | | | Release |
| | Specific | | Linear | Defective |
| Cleaning | Resistance | Ra | Transmittance | (per 10 |
| Water | MΩ · cm | Nm | % | sheets) |
| 1 | 18 | <1 | ≧91 | 0 |
| 2 | 17 | 1-8 | ≧90 | 0 |
| 3 | 15 | 5-12 | ≧88 | 0 |
| 4 | 13 | 8-20 | ≧86 | 0 |
| 5 | 10 | 10-28 | ≧78 | 2 |

Fabrication of Forming Mold for Micro Lens Array)

A Cr film was formed on the quartz glass substrate (5 mm thick, dimensions of 50 mm by 50 mm) by a sputtering method. A photo resist was applied on the Cr film by a spin coating method. Then, the photo resist film was exposed to light with a pattern in which 50 opening portions were arranged longitudinally and 50 opening portions were arranged laterally, that is, 2500 opening portions in total were arranged so as to be shaped like a grid. The exposed portions of the photo resist were developed and removed. While the photo resist film was use as a mask, the Cr film was etched to thereby form openings.

After pre-cleaned with the cleaning waters 1-5 respectively, the glass substrate coated with the photo resist-including Cr film was etched with 49% hydrofluoric acid. Then, after the glass substrate was post-cleaned with the cleaning water same as the pre-cleaning, the photo resist film was removed by an aqueous solution of NaOH.

After the Cr mask was further separated and removed by an aqueous solution of 2-ammonium cerium nitrate, the quartz glass substrate was cleaned with the same cleaning water. Then, the quartz glass substrate was etched with 49% hydrofluoric acid in the second etching step. Then, the quartz glass substrate was cleaned with the same cleaning water. Thus, a micro-lens forming mold as shown in step (e) in FIG. 1 was obtained. Each of the concave portions obtained was shaped like a spherical bowl. Opening portions were longitudinally close to one another. Each concave portion had a curvature radius of 1.75 mm, an aperture size of 1.00 mm and a depth of 73 μm.

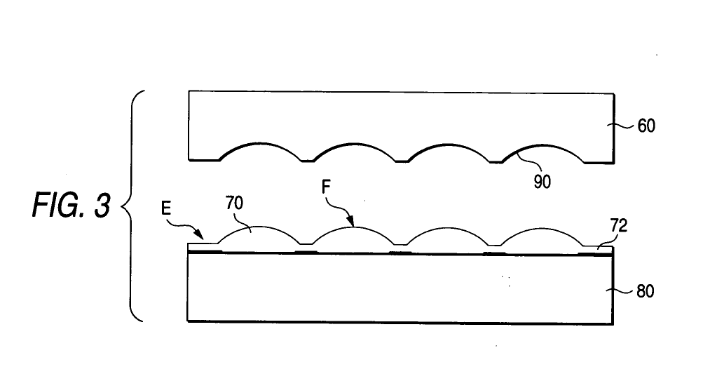

Then, as shown in FIG. 3, the glass forming mold 60 was used for forming a resin convex lens array 70 on a glass substrate 80.

A 0.7 mm-thick 50 mm-square quartz glass substrate was used as the glass substrate 80 after ultrasonic alkali cleaning and pure water cleaning.

An ultraviolet-curable epoxy resin was used as a molding resin 72. The epoxy resin was applied on a single-side surface of the glass substrate so that the thickness of the epoxy resin was about 100 μm.

To improve mold releasability, a fluororesin was applied on the surface of the forming mold 60 by a spin coating method to form a releasing agent layer 90.

The molding resin 72 was irradiated with ultraviolet rays having intensity of 120 mW/cm² from the substrate side at room temperature for 3 minutes. After that, the forming mold was released At this time, relationship between the mold releasability of the forming mold and the cleaning water used in the fabrication thereof was investigated. The test result is shown in Table 1. Number of sheets in which mold release defective is occurred per 10 sheets of the substrates are shown in Table 1. Only in the case where the cleaning water 5 was used, the defective that the formed resin partially remains on the surface of the forming mold was occurred in two sheets among 10 sheets. It is indicated that the releasability of the mold deteriorates in a case that the surface roughness is high.

(Fabrication of Microlens Array)

In a case that the cleaning water 1, which has specific resistance of 18 M Ω·cm, is used for fabricating a microlens array as described below. When the surface roughness of the portions C and D of the glass was measured, the center-line average roughness Ra was 1 nm (after etching in the step (e) of FIG. 1).

After molding, the thickness of the thinnest region of the resin layer 72 was about 20 μm, and the largest film thickness from the top of each spherical convex portion was 91.5 μm. The center-line average roughness Ra of lens surfaces E and F which had come into contact with the forming mold was not larger than 7 nm. The resin layer was transparent and had a refractive index of 1.50. An epoxy group polymerization portion [—(CH₂)₃OCO(CH₂)₄COO(CH₂)₃—] was contained in the film.

The focal length of each micro convex lens (micro-lens) 50 was in a range of from 3.297 mm to 3.300 mm.

When the heights of the spherical convex portions were measured at 100 points selected at random from one substrate, the average height was 71.5 μm based on the standard deviation of 0.12 μm. The root mean square (RMS) value of spherical aberration of the micro-lens 50 measured by a He—Ne laser beam (λ=633 nm) was 0.05 λ based on the standard deviation of 0.001 λ.

In the condition that parallel rays were made perpendicularly incident to the convex lenses from the side opposite to the film, the diameters of convergent light spots were measured. As a result, the diameter of each of the convergent light spots based on all the convex lenses was not larger than 3 μm. This value did not change after the heat resistance/humidity resistance test.

The lens array was cleaned in an aqueous solution containing a neutral detergent at 70° C. for 30 minutes and further cleaned in pure water at 70° C. for 30 minutes. As a result, separation of the resin lens layer from the substrate surface was not observed.

Although this embodiment has been described on the case where the lens array is formed by mold releasing after molding of the resin as shown in FIG. 3, the lens function can be given to the forming mold filled with the resin if a material having a higher refractive index than that of the forming mold is selected as the material of the resin.

In this case, the forming mold is directly used as a substrate as represented by a configuration example described in JP H03-232743A, so that a planar lens or lens array having no convex portion on its surface can be achieved. Accordingly, it is the essential condition that the forming mold (substrate) is transparent. Glass is a preferred material. The invention can be also applied to this case because it is important that the surface of the concave portion of the forming mold (substrate) is flat.

Although the invention has been described while production of a forming mold having a concave portion formed in a substrate surface by etching has been taken as an example, the invention can be applied to other purposes. For example, a leading end portion of a core of an optical fiber may be processed into a convex shape to give the lens function to the leading end portion of the core or reduce end surface reflection. The invention can be applied to this case so that the surface roughness of the leading end portion of the optical fiber can be reduced to thereby reduce light scattering on the surface when the leading end portion of the optical fiber is processed into a convex shape.

The material of the solid body to be etched is not limited to glass described above as an example. In the field of semiconductor, there is some case where the surface needs to be flattened in atomic level. The invention can be applied to this purpose. The case where silicon is etched with an aqueous solution of hydrofluoric acid or the case where gallium arsenide (GaAs) is etched with a mixture aqueous solution containing sulfuric acid and aqueous hydrogen peroxide can be shown as an example.

1. An etched article comprising:
a solid base material, a surface of which is etched such that an aqueous solution containing a component capable of dissolving said base material is brought into contact with said base material, wherein a center-line average roughness Ra of the etched surface of said base material is not larger than 20 nm.

2. An etched article according to claim 1, wherein the center-line average roughness Ra of the etched surface of said base material is not larger than 8 nm.

3. An etched article according to claim 1, wherein said aqueous solution is brought into contact with only a predetermined portion of said surface of said base material to thereby form a concave or convex portion.

4. An etched article according to claim 1, wherein said base material is glass.

5. An etched article according to claim 4, wherein said glass is one member selected from the group consisting of quartz glass, non-alkali glass, and soda-lime silicate glass.

6. A mold structure comprising an etched article defined in claim 3, and a fluid substance hardened after filled in said concave portion of the surface of said etched article.

7. A mold structure according to claim 6, wherein said etched article and said hardened fluid substance are transparent to light with a predetermined wavelength and
said etched article and said hardened fluid substance are different in refractive index from each other.

8. A mold structure according to claim 7, wherein said etched article has a concave portion substantially shaped like a semi-circle in sectional view.

9. A mold structure comprising a fluid substance hardened after filled in the concave portion of the surface of an etched article defined in claim 3, said fluid substance being separated from said etched article after hardened, wherein the center-line average roughness Ra of a portion of the surface of said mold structure having been brought into contact with said etched article is not larger than 20 nm.

10. A mold structure according to claim 9, wherein the center-line average roughness Ra of a portion of the surface of said mold structure having been brought into contact with said etched article is not larger than 8 nm.

11. A mold structure according to claim 10, wherein said mold structure is transparent to light with a predetermined wavelength.

12. A mold structure according to claim 9, wherein said etched article has a concave portion substantially shaped like a semi-circle in sectional view.

13. A method of producing an etched article, comprising the steps of:
contacting an aqueous solution with a surface of a base material, said aqueous solution containing a component capable of dissolving said base material;
etching a predetermined portion of said surface of said base material;
forming a concave or convex portion in said predetermined portion of said surface of said base material,
wherein the specific resistance of water used for adjusting said aqueous solution and water used for cleaning before and after etching is not lower than 13 M Ω·cm.

14. A method of producing an etched article according to claim 13, wherein the specific resistance of water used for adjusting said aqueous solution and water used for cleaning before and after etching is not lower than 15 M Ω·cm.

15. A method of producing an etched article according to claim 13, wherein the specific resistance of water used for adjusting said aqueous solution and water used for cleaning before and after etching is not lower than 17 M Ω·cm.

16. A method of producing an etched article according to claim 13, wherein said base material is glass.

17. A method of producing an etched article according to claim 16, wherein said glass is one member selected from the group consisting of quartz glass, non-alkali glass, and soda-lime silicate glass.

18. A method of producing an etched article according to claim 16, wherein said component capable of dissolving said base material is hydrofluoric acid.

19. A method of producing a mold structure, comprising the steps of:
forming a releasing agent layer in a concave portion of a surface of an etched article having a center-line average roughness Ra of not larger than 20 nm;
injecting a fluid substance in said concave portion; hardening said fluid substance; and
separating said fluid substance from said etched article.

20. A method of producing a mold structure, according to claim 19, wherein said etched article having the center-line average roughness Ra of not larger than 8 nm.
